(19) United States
(12) Patent Application Publication
(10) Pub. No.: US 2005/0171318 A1
(43) Pub. Date: Aug. 4, 2005

(54) Curable resin composition

(75) Inventors: Hiroyuki Okuhira, Kanagawa (JP); Tomoyuki Matsumura, Kanagawa (JP); Kazunori Ishikawa, Kanagawa (JP); Natsuki Hamada, Kanagawa (JP); Keiko Miura, Kanagawa (JP); Hiroyuki Hosoda, Kanagawa (JP); Mitsukazu Ochi, Osaka (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: THE YOKOHAMA RUBBER CO., LTD.

(21) Appl. No.: 11/047,771

(22) Filed: Feb. 2, 2005

(30) Foreign Application Priority Data
Feb. 3, 2004 (JP) 2004-026631

(51) Int. Cl. C08G 77/04

(52) U.S. Cl. 528/34; 528/12

(57) ABSTRACT

A curable resin composition includes a silane compound (a) having an epoxy group, and at least one selected from a silane compound (b) having an amino group, a silane compound (c) having a mercapto group, and a silane compound (d) having an acid anhydride group. At least a part of at least one selected from the silane compounds (a) to (d) includes a condensate. This composition has excellent heat resistance with a small change in storage modulus due to temperatures.

The present application is a U.S. patent application, which is filed while claiming priority benefit of Japanese patent applications Nos. 2004-026631 and 2004-199563. Therefore, the entire contents of these applications, as well as the specifications and drawings of other patent applications and the contents of non-patent documents cited in the present application, are entirely incorporated hereinto by reference.

### BACKGROUND OF THE INVENTION

The present invention relates to a curable resin composition having excellent heat resistance.

In recent years, cured epoxy resin products have been desired to have improved properties depending on uses. For instance, such an improvement in heat resistance has been desired in the fields of electronic parts such as printed circuit boards and semiconductor sealants and fiber reinforced plastics (FRPs) fabricated with arrangement of prepreg of a reinforced fiber material, more specifically in the field of aircraft.

An epoxy silica hybrid body has been noticed as the epoxy resin composition excellent in heat resistance. JP 2001-59013 A, for example, discloses an epoxy resin composition containing: a silane-modified epoxy resin having an alkoxy group, which is obtained by a dealcoholization reaction between a bisphenol epoxy resin having a hydroxyl group and hydrolyzable alkoxysilane; and a curing agent.

Furthermore, the inventors of the present invention have proposed, as a curable resin composition prepared using an epoxy silica hybrid body excellent in heat resistance, a two-component curable resin composition consisting of first and second liquids, where the first liquid contains a ketimine oligomer obtained by reacting a primary amino group-containing alkoxysilyl compound having a primary amino group and an alkoxysilyl group with ketone and the second liquid contains a compound having an epoxy group (see, e.g., Hiroyuki Okuhira et al., “Novel Moisture Curable Epoxy Resins and Epoxy/Silica Hybrids Using Latent Hardeners”, Proceedings of the 25th Annual Meeting of The Adhesion Society, Inc. and The Second World Congress on Adhesion and Related Phenomena (WCARP-11), p. 48-50, Feb. 10, 2002).

In addition, JP 2004-43696 A discloses a silicon compound having an epoxy group, which is characterized by including a structure described below and an alkoxy group in its molecule to have high heat resistance. 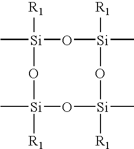
wherein each R₁ represents a substituent having an epoxy group, an alkyl group having not more than 10 carbon atoms, an aryl group, or an unsaturated aliphatic residue, and one R₁ may be different from or identical with another R₁ and at least one R₁ is a substituent having an epoxy group.

Furthermore, for improving mechanical characteristics of thermosetting resins such as phenol resins, epoxy resins, and unsaturated polyester resins, JP 2003-221446 A describes a method of improving mechanical characteristics of a resin. The method is characterized by the use of a condensate made of an oligomer having a molecular weight of not more than 10,000. The condensate can be prepared by repeatedly subjecting an alkoxysilane group of a silane coupling agent having an organic functional group that reacts/interacts with a liquid resin to hydrolysis and then to dehydration condensation.

Moreover, JP 9-111188 A describes a coating material composition which can form a coating film for attaining excellent abrasion resistance, weather resistance, adhesion, anti-pollution property, water-proof, and chemical resistance. More specifically, there is described a coating material composition containing (A) an organic resin and (B) a silicone compound represented by an average composition formula (1):
(X)ₐ(Y′)_{b}(R¹)_{c}SiO_{(4-a-b-c)/2} (1)
[wherein X is an organic group having at least one functional group selected from the group consisting of an epoxy group, a mercapto group, a (meth)acryloyl group, an alkenyl group, a haloalkyl group, and an amino group, Y′ is a hydrolyzable group or a mixture of a hydrolyzable group and a silanol group (but the silanol group accounts for 20% by mole or less of Y′), R¹ is a monovalent hydrocarbon group, a is a number of 0.05 to 0.90, b is a number of 0.12 to 1.88, and c is a number of 0.10 to 1.00, where a+b+c is in the range of 2.02 to 2.67)], where the amount of the silicon atoms coupled with the functional group-containing organic groups X is 5 to 90% by mole with respect to the total amount of silicon atoms in a molecule, the ratio of a T unit represented by R¹—SiO_{3/2} is 10 to 95% by mole with respect to the entire siloxane unit, and the average degree of polymerization is 3 to 100.

On the other hand, JP 2003-287617 A describes a thermosetting resin solution composition for a color filter, characterized by including: a compound containing at least one of alkoxysilane, silanol, and a silanol condensate and an acid anhydride in a single molecule; and an epoxy compound containing, on its side chain, a group having a planer structure with a molecular weight of 70 to 1,000.

For the curable resin composition described in H. Okuhira et al. (cited above), however, a further improvement in rate of change (retention) of the storage modulus has been needed even though the curable resin composition has been considered to have sufficiently good heat resistance as estimated from a change in storage modulus because of disappearance of its glass transition point (Tg).

Furthermore, JP 2004-43696 A describes that the epoxy group-containing silicon compound can be used in combination with a general-purpose curing agent. Therefore, the heat resistance of the resin is susceptible to further improvement. Moreover, the epoxy group-containing silicon compound has poor storage stability and thus it will be gelated over time. As the compound has the structure represented by the above formula, the compound may form a dense three-dimensional network structure, causing an increase in its viscosity.

Neither JP 2003-221446 A nor JP 09-111188 A has a description about heat resistance or storage stability. Therefore, those features of the compounds should be further investigated.

Furthermore, the compound containing at least one of alkoxysilane, silanol, and a silanol condensate and an acid anhydride in the single molecule is generally in a solid state at room temperature, so it should be diluted with a polar solvent before use. Thus, a cured product can be produced with poor workability, resulting in poor physical properties (e.g., heat resistance) thereof and causing a large impact on the environment.

### SUMMARY OF THE INVENTION

Therefore, an object of the present invention is to provide a curable resin composition, which is prepared using an epoxy silica hybrid body, and which has more excellent heat resistance than that of the conventional composition and more particularly has substantially small changes in storage modulus (G′) at lower and higher temperatures. Another object of the present invention is to provide a curable resin composition having excellent workability with low viscosity as well as the above features and also having excellent storage stability.

The inventors of the present invention have made intensive studies and found that a cured product can exhibit excellent heat resistance and in particular substantially reduce any changes in storage modulus (G′) at lower and higher temperatures by means of a curable resin composition containing: a silane compound having an epoxy group (oxirane ring); and at least one selected from the group consisting of a silane compound having an amino group, a silane compound having a mercapto group, and a silane compound having an acid anhydride group.

Consequently, the inventors of the present invention have completed the present invention on the basis of those findings. In other words, the present invention provides the following (1) to (14):
1. A curable resin composition including:

a silane compound (a) where an epoxy group binds to a silicon atom through an organic group that may contain a nitrogen atom or an oxygen atom, and at least one selected from the group consisting of:

a silane compound (b) where an amino group binds to a silicon atom through an organic group that may contain a nitrogen atom or an oxygen atom;

a silane compound (c) where a mercapto group binds to a silicon atom through an organic group that may contain a nitrogen atom or an oxygen atom; and

a silane compound (d) where an acid anhydride group binds to a silicon atom through an organic group that may contain a nitrogen atom or an oxygen atom, in which at least a part of at least one selected from the group consisting of the silane compound (a), the silane compound (b), the silane compound (c), and the silane compound (d) is a condensate.
2. The curable resin composition according to the above item 1, in which the condensate of the silane compound (a) is a condensate of 3-glycidoxypropyltrialkoxysilane.
3. The curable resin composition according to the above item 1, in which the condensate of the silane compound (a) is obtained by subjecting an alkoxysilane containing at least an epoxy group-containing alkoxysilane to a hydrolytic condensation reaction.
4. The curable resin composition according to the above item 3, in which the condensate of the silane compound (a) is obtained by subjecting the alkoxysilane containing at least an epoxy group-containing alkoxysilane to a reaction with 0.5 to 1.3 times mole (molar ratio) of water with respect to silicon atoms of the alkoxysilane containing at least an epoxy group-containing alkoxysilane.
5. The curable resin composition according to the above item 1, in which the condensate of the silane compound (a) contains 60 to 100% by mole of epoxy groups with respect to silicon atoms of the condensate of the silane compound (a).
6. The curable resin composition according to the above item 1, in which the condensate of the silane compound (b) is a condensate of an amino group-containing alkoxysilane.
7. The curable resin composition according to the above item 1, in which the condensate of the silane compound (c) is obtained by subjecting an alkoxysilane containing at least a mercapto group-containing alkoxysilane to a hydrolytic condensation reaction.
8. The curable resin composition according to the above item 7, in which the condensate of the silane compound (c) is obtained by subjecting the alkoxysilane containing at least a mercapto group-containing alkoxysilane to a reaction with 0.5 to 1.3 times mole of water with respect to silicon atoms of the alkoxysilane containing at least a mercapto group-containing alkoxysilane.
9. The curable resin composition according to the above item 1, in which the condensate of the silane compound (c) contains 60 to 100% by mole of mercapto groups with respect to silicon atoms of the condensate of the silane compound (c).
10. The curable resin composition according to the above item 1, in which the condensate of the silane compound (d) is obtained by subjecting an alkoxysilane containing at least an acid anhydride group-containing alkoxysilane to a hydrolytic condensation reaction.
11. The curable resin composition according to the above item 10, in which the condensate of the silane compound (d) is obtained by subjecting the alkoxysilane containing at least an acid anhydride group-containing alkoxysilane to a reaction with 0.5 to 1.3 times mole of water with respect to silicon atoms of the alkoxysilane containing at least an acid anhydride group-containing alkoxysilane.
12. The curable resin composition according to the above item 1, in which the condensate of the silane compound (d) contains 60 to 100% by mole of an acid anhydride group with respect to silicon atoms of the condensate of the silane compound (d).
13. The curable resin composition according to the above item 1, further containing a curing catalyst.
14. A cured product obtainable by curing a curable resin composition including:

a silane compound (a) where an epoxy group binds to a silicon atom through an organic group that may contain a nitrogen atom or an oxygen atom, and

at least one selected from the group consisting of:

a silane compound (b) where an amino group binds to a silicon atom through an organic group that may contain a nitrogen atom or an oxygen atom;

a silane compound (c) where a mercapto group binds to a silicon atom through an organic group that may contain a nitrogen atom or an oxygen atom; and

a silane compound (d) where an acid anhydride group binds to a silicon atom through an organic group that may contain a nitrogen atom or an oxygen atom,

in which at least a part of at least one selected from the group consisting of the silane compound (a), the silane compound (b), the silane compound (c), and the silane compound (d) is a condensate.

### DETAILED DESCRIPTION OF THE INVENTION

Hereinafter, the present invention will be described in detail.

The curable resin composition of the present invention contains a silane compound (a) where an epoxy group binds to a silicon atom through an organic group that may contain a nitrogen atom or an oxygen atom, and at least one selected from the group consisting of a silane compound (b) where an amino group binds to a silicon atom through an organic group that may contain a nitrogen atom or an oxygen atom, a silane compound (c) where a mercapto group binds to a silicon atom through an organic group that may contain a nitrogen atom or an oxygen atom, and a silane compound (d) where an acid anhydride group binds to a silicon atom through an organic group that may contain a nitrogen atom or an oxygen atom, and at least a part of at least one selected from the group consisting of the silane compounds (a) to (d) is a condensate.

Incidentally, in the curable resin composition of the present invention, the phrase “at least a part of at least one selected from the group consisting of the silane compounds (a) to (d) is a condensate” refers to either of: (i) at least a part of each of the silane compounds (a) to (d) is a condensate; or (ii) at least a part of the silane compound (a) is condensed with at least a part of at least one selected from the group consisting of the silane compounds (b) to (d) to form a condensate, or alternatively means both the above items (i) and (ii).

<Silane compound (a) where an epoxy group binds to a silicon atom through an organic group that may contain a nitrogen atom or an oxygen atom>

The silane compound (a) where an epoxy group binds to a silicon atom through an organic group that may contain a nitrogen atom or an oxygen atom, as used in the curable resin composition of the present invention, is not particularly limited as far as it is a silane compound in which an epoxy group binds to a silicon atom through an organic group that may contain a nitrogen atom or an oxygen atom and at least a part of the silane compound is a condensate. Hereinafter, the condensate of the silane compound (a) may be also referred to as “an epoxy group-containing silicone compound”.

Thus, for example, the silane compound (a) may be an epoxy group-containing alkoxysilane or a condensate thereof.

The epoxy group-containing alkoxysilane is not particularly limited as far as it is an alkoxysilane having at least one alkoxysilyl group, in which at least one epoxy group binds to a silicon atom through an organic group that may contain a nitrogen atom or an oxygen atom. Specific examples of the epoxy group-containing alkoxysilane include one having a cross-linkable silyl group and represented by the following general formula (1): 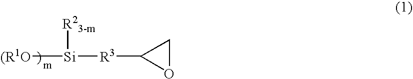
wherein:

m is an integer number of 1 to 3;

R¹ represents an alkyl group having 1 to 3 carbon atoms, preferably a methyl group, an ethyl group, an n-propyl group, or an isopropyl group, more preferably a methyl group or an ethyl group, and if there is more than one R¹, one R¹ may be identical with or different from another R¹;

R² represents an alkyl group having 1 to 6 carbon atoms, preferably a methyl group, an ethyl group, an n-propyl group, or an isopropyl group, more preferably a methyl group or an ethyl group, and if there is more than one R², one R² may be identical with or different from another R2; and

R³ represents an organic group that may contain a nitrogen atom or an oxygen atom, preferably a divalent noncyclic aliphatic group having 3 to 6 carbon atoms or a divalent alicyclic group having 6 to 10 carbon atoms that may contain an oxygen atom.

Examples of an epoxy group-containing alkoxysilane include: 3-glycidoxypropyltrialkoxysilanes or 3-glycidoxypropylalkyldialkoxysilanes such as 3-glycidoxypropyltrimethoxysilane, 3-glycidoxypropylmethyldimethoxysilane, 3-glycidoxypropylmethyldiethoxysilane, and 3-glycidoxypropyltriethoxysilane; and 2-(3,4-epoxycyclohexyl)ethyltrialkoxysilanes or 2-(3,4-epoxycyclohexyl)ethylalkyldialkoxysilanes such as 2-(3,4-epoxycyclohexyl)ethyltrimethoxysilane, 2-(3,4-epoxycyclohexyl)ethylmethyldimethoxysilane, 2-(3,4-epoxycyclohexyl)ethylmethyldiethoxysilane, and 2-(3,4-epoxycyclohexyl)ethyltriethoxysilane. Each of them can be used alone, or two or more of them can be used in combination.

Furthermore, a commercially available product can be used for the epoxy group-containing alkoxysilane, and specific examples thereof include A186 and A187 (available from Nippon Unicar Co., Ltd.) and KBE-402 and KBE-403 (available from Shin-Etsu Chemical Co., Ltd.).

The condensate of the silane compound (a) is not particularly limited as far as it is a compound having a siloxane skeleton, in which at least one epoxy group binds to a silicon atom through an organic group that may contain a nitrogen atom or an oxygen atom. For example, the condensate of the silane compound (a) may be one made of the epoxy group-containing alkoxysilane having a cross-linkable silyl group and represented by the general formula (1). The specific examples of the epoxy group-containing alkoxysilane represented by the general formula (1) can be used for the epoxy group-containing alkoxysilane.

Furthermore, specific examples of the condensate of the silane compound (a) include one having a structure in which an epoxy group binds to a siloxane skeleton through an organic group that may contain a nitrogen atom or an oxygen atom, where the siloxane skeleton is a chain-like, ladder-like, or basket-like siloxane skeleton represented by the following formula (2), (3) or (4), or a combination thereof. The chain-like structure represented by the following formula (2) is preferable because of excellent workability and storage stability as well as low viscosity.

Incidentally, when the chain-like siloxane skeleton represented by the formula (2) is formed, a silane residue uninvolved in a siloxane bond and the binding with an epoxy group is at least one selected from the group consisting of an alkoxysilyl group and a silanol group.

Furthermore, the condensate of the silane compound (a) is preferably a condensate of 3-glycidoxypropyltrialkoxysilane because its raw materials can be easily obtained and it has high reactivity.

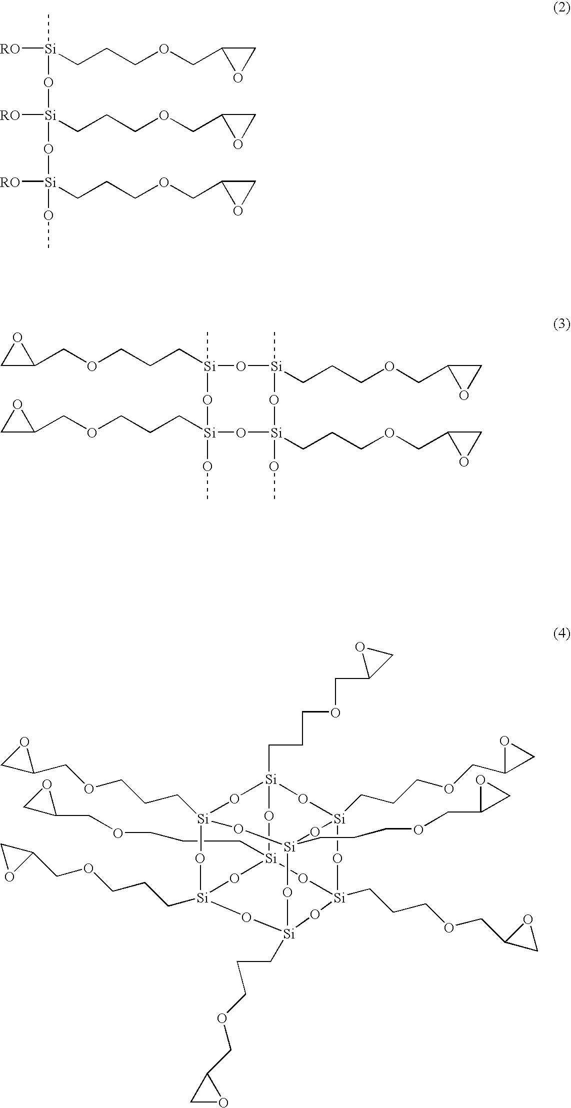

In the above formula (2), each R represents a hydrogen atom or an alkyl group having 1 to 3 carbon atoms, independently.

A manufacturing method for the condensate of the silane compound (a) is not particularly limited. Examples thereof include a method in which an alkoxysilane containing at least an epoxy group-containing alkoxysilane is subjected to a hydrolytic condensation reaction to obtain the condensate and a method in which the condensate is synthesized by forming a siloxane skeleton and introducing a compound having an epoxy group into the siloxane skeleton. Of those, in a preferred embodiment, the method in which the alkoxysilane containing at least an epoxy group-containing alkoxysilane is subjected to a hydrolytic condensation reaction to obtain the condensate of the silane compound (a) is utilized.

As used herein, the term “hydrolytic condensation reaction” means that an alkoxysilyl group is hydrolized and then the resulting hydroxysilyl group is condensed by means of a dealcoholization reaction with another alkoxysilyl group or condensed by means of a dehydration reaction with another hydroxysilyl group.

Incidentally, for the production of the epoxy group-containing alkoxysilane, as alcohol is generated when a siloxane bond is formed by means of hydrolysis and condensation, it is preferable to remove the alcohol under reduced pressure.

Examples of a raw material used in the production of the condensate of the silane compound (a) include an alkoxysilane containing at least an epoxy group-containing alkoxysilane. Examples of the alkoxysilane other than the epoxy group-containing alkoxysilane include: silane compounds having, in their respective molecules, functional groups such as a vinyl group, an acryl group, a methacryl group, and an isocyanate group (hereinafter, also referred to as “substituted alkoxysilane”); and alkoxysilanes represented by the formula (5) including tetraalkoxysilanes such as tetramethoxysilane and tetraethoxysilane, and trialkoxysilanes such as methyl trimethoxysilane and ethyl trimethoxysilane.

The condensate of the silane compound (a) may be one prepared by allowing the epoxy group-containing alkoxysilane to be condensed, for example, in combination with substituted alkoxysilane, the alkoxysilane represented by the formula (5) or condensates thereof. If a silane compound having a functional group other than the epoxy group is used in combination with the epoxy group-containing alkoxysilane, the condensate preferably contains at least 60% by mole of the epoxy group-containing alkoxysilane in terms of heat resistance. The condensate more preferably contains not less than 80% by mole of the epoxy group-containing alkoxysilane because it will provide more excellent heat resistance.
(R¹O—)ₘ—Si—R²₄₋ₘ (5)

In the above formula (5), m is an integer number of 2 to 4, and R¹ and R2 are as defined above, respectively.

Furthermore, it is preferable that the condensate of the silane compound (a) have 60 to 100% by mole of epoxy groups with respect to the silicon atoms in the condensate of the silane compound (a) because the condensate will be excellent in heat resistance. It is more preferable that the condensate contain 80 to 100% by mole of the epoxy groups with respect to the silicon atoms in the condensate of the silane compound (a) because the condensate will provide more excellent heat resistance.

Incidentally, as stated previously, the epoxy group-containing silicon compound described in JP 2004-43696 A having the structure represented by the above formula has been disadvantageous because of high viscosity, poor storage stability, and gelation with time.

The inventors of the present invention have made intensive studies and found that the condensate of the silane compound (a) having excellent storage stability and low viscosity can be obtained by carrying out a hydrolytic condensation reaction of the alkoxysilane containing at least the epoxy group-containing alkoxysilane under certain conditions. More specifically, preferable is a condensate of the silane compound (a) obtained by allowing the alkoxysilane containing at least the epoxy group-containing alkoxysilane to react with 0.5 to 1.3 times mole of water with respect to the silicon atoms of the alkoxysilane containing at least the epoxy group-containing alkoxysilane. The hydrolytic condensation reaction is carried out under this condition and the degree of condensation of the resulting condensate of the silane compound (a) is then adjusted to obtain the condensate of the silane compound (a) having excellent heat resistance and storage stability as well as low viscosity. Consequently, the curable resin composition of the present invention has low viscosity while being excellent in heat resistance and storage stability. As the curable resin composition of the present invention is superior in those features to the conventional one, the amount of water to be reacted with the silicon atoms of the-alkoxysilane containing at least the epoxy group-containing alkoxysilane is preferably 0.6 to 1.3 times mole, more preferably 0.8 to 1.2 times mole. Incidentally, when the epoxy group-containing alkoxysilane is used in combination with another alkoxysilane such as the substituted alkoxysilane described above for hydrolytic condensation reaction, water may be added in the amount defined above with respect to the total amount of the silicon atoms.

The condensate of the silane compound (a) has preferably a weight average molecular weight of 450 to 10,000 in that the heat resistance is excellent and its viscosity is not too high. The weight average molecular weight is more preferably 700 to 9,000, still more preferably 1,000 to 8,000 in terms of these excellent features.

Of conventionally known catalysts that promotes the condensation of alkoxysilanes, a catalyst which is not involved in the ring-opening of epoxy group can be used for the hydrolytic condensation reaction described above. Specific examples of the catalysts include metals such as lithium, sodium, potassium, rubidium, cesium, magnesium, calcium, barium, strontium, zinc, aluminum, titanium, cobalt, germanium, tin, lead, antimony, arsenic, cerium, cadmium, and manganese, oxides thereof, organic acid salts, halides thereof, and alkoxides thereof. Of those, particularly, organic tin, organic acid tin, and alkoxytitanium are preferable, and dibutyltin dilaurate is particularly preferable. The amount of the catalyst added is preferably 0.01 to 5% by weight, more preferably 0.05 to 3% by weight with respect to the sum of the epoxy group-containing alkoxysilane and another alkoxysilane such as the substituted silane.

The hydrolytic condensation reaction can be carried out in the presence or absence of a solvent. For instance, the solvent may be one that dissolves the alkoxysilane containing the epoxy group-containing alkoxysilane, but is not specifically limited. Specific examples of the solvent include polar solvents such as dimethylformamide, dimethylacetamide, tetrahydrofuran, methyl ethyl ketone, and alcohols (e.g., methanol).

The curable resin composition of the present invention includes: the silane compound (a); and at least one selected from the group consisting of a silane compound (b) where an amino group binds to a silicon atom through an organic group that may contain a nitrogen atom or an oxygen atom, a silane compound (c) where a mercapto group binds to a silicon atom through an organic group that may contain a nitrogen atom or an oxygen atom, and a silane compound (d) where an acid anhydride group binds to a silicon atom through an organic group that may contain a nitrogen atom or an oxygen atom. The curable resin composition preferably contains at least one selected from the group consisting of the silane compound (b), the silane compound (c) and the silane compound (d) as the curing agent for the silane compound (a).

It is thought that the curable resin composition of the present invention may have dramatically improved heat resistance because of the following reasons. The curable resin composition of the present invention also uses a compound having a siloxane skeleton for the curing agent, so the proportion of the siloxane skeleton contained in the cured product of the curable resin composition of the present invention becomes higher than that of the curable resin composition containing the conventional epoxy silica hybrid body (see, e.g., JP 2004-43696 A).

In the curable resin composition of the present invention, the ratio of the content of at least one selected from the group consisting of the silane compound (b), the silane compound (c), and the silane compound (d) to the content of the silane compound (a) is preferably defined such that the equivalent ratio of the epoxy group of the silane compound (a) to the active hydrogen of the amino group of the silica compound (b); the active hydrogen of the mercapto group of the silane compound (c); and the active hydrogen of the carboxyl group that can be generated from the silane compound (d) is 0.5 to 1.5, more preferably 0.8 to 1.2. If the ratio of the content of the silane compound (a) to the content of at least one selected from the group consisting of the silane compound (b), the silane compound (c), and the silane compound (d) is within these ranges, the retention of the storage modulus of the resulting curable resin composition will be highly increased and the heat resistance thereof will be markedly improved. Therefore, the ranges defined above are preferable.

Furthermore, in the curable resin composition of the present invention, the equivalent ratio of the active hydrogen of the amino group of the silica compound (b); the active hydrogen of the mercapto group of the silane compound (c); and the active hydrogen of the carboxyl group that can be generated from the silane compound (d) to the epoxy group of the silane compound (a) is preferably 0.5 to 1.5, more preferably 0.8 to 1.2. If the ratio of the content of at least one selected from the group consisting of the silane compound (b), the silane compound (c), and the silane compound (d) to the content of the silane compound (a) is within these ranges, the retention of the storage modulus of the resulting curable resin composition will be highly increased and the heat resistance thereof will be markedly improved.

<Silane compound (b) where an amino group binds to a silicon atom through an organic group that may contain a nitrogen atom or an oxygen atom>

The silane compound (b) where an amino group binds to a silicon atom through an organic group that may contain a nitrogen atom or an oxygen atom, as used in the curable resin composition of the present invention, is not particularly limited as far as it is a silane compound where an amino group binds to a silicon atom through an organic group that may contain a nitrogen atom or an oxygen atom and at least a part of the silane compound is a condensate.

Here, the term “amino group”, which is contained in the silane compound (b) where the amino group binds to a silicon atom through an organic group that may contain a nitrogen atom or an oxygen atom, refers to a primary amino group (—NH₂) or a secondary amino group (imino group: —NH—).

For instance, the silane compound (d) may be an amino group-containing alkoxysilane or a condensate thereof.

The amino group-containing alkoxysilane is not particularly limited as far as it is an alkoxysilane compound having at least one alkoxysilyl group, in which at least one amino group binds to a silicon atom through an organic group that may contain a nitrogen group or an oxygen group. Specific examples of the alkoxysilane containing the amino group include compounds represented by the following general formulae (6) to (8), each of which has a cross-linkable silyl group.

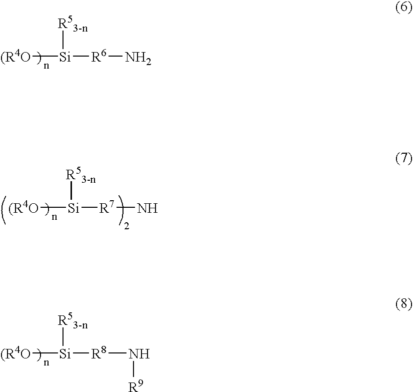

In the above general formula (6):

n represents an integer number of 1 to 3;

R⁴ and R⁵ are basically as defined above for R¹ and R² in the general formula (1), respectively; and

R⁶ represents an organic group that may contain a nitrogen atom or an oxygen atom, preferably a divalent noncyclic aliphatic group having 2 to 8 carbon atoms that may contain a nitrogen atom.

Specific examples of the amino group-containing alkoxysilane represented by the general formula (6) include γ-aminopropyltrimethoxysilane, γ-aminopropyltriethoxysilane, and compounds represented by the following formulae (9) and (14).

Of those, the compounds represented by the formulae (9) and (10) are preferable because of the following reasons. Those compounds easily form cured products because of smaller volume of generated alcohol and tend to form three-dimensional silica networks at the time of curing. Then, cross-linking density is increased and the retention of storage modulus can be improved.

In addition, a commercially available product can be used for the amino group-containing alkoxysilane represented by the general formula (6). Specific examples thereof include A1110 and A1100 (available from Nippon Unicar Co., Ltd.) and KBM-903 and KBE-903 (available from Shin-Etsu Chemical Co., Ltd.).

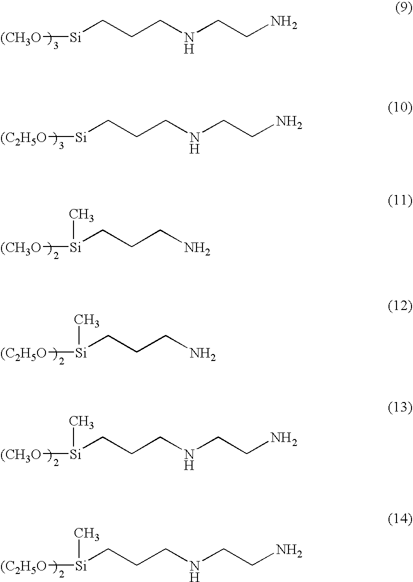

In the above general formula (7):

n represents an integer number of 1 to 3;

R⁴ and R⁵ are basically as defined above for R¹ and R² in the general formula (1), respectively; and

R⁷ represents an alkylene group having 1 to 12 carbon atoms, specific examples include a methylene group, an ethylene group, a trimethylene group, a tetramethylene group, a pentamethylene group, a hexamethylene group, or an octamethylene group, with a trimethylene group being preferable, and one R⁷ may be identical to or different from another R⁷.

Preferable specific examples of the amino group-containing alkoxysilane represented by the general formula (7) include N,N-bis[(3-trimethoxysilyl)propyl]amine, N,N-bis[(3-triethoxysilyl)propyl]amine, N,N-bis[(3-tripropoxysilyl)propyl]amine, N,N-bis[(3-methoxydimethoxysilyl)propyl]amine, and N,N-bis[(3-ethoxydiethoxysilyl)propyl]amine.

Of those, N,N-bis[(3-trimethoxysilyl)propyl]amine is preferable, because this compound easily forms a cured product due to smaller volume of generated alcohol and tends to form a three-dimensional silica network at the time of curing, thus leading to increase of cross-linking density and improvement of the retention of storage modulus.

In the general formula (8):

n represents an integer number of 1 to 3;

R⁴ and R⁵ are basically as defined above for R¹ and R² in the general formula (1), respectively;

R⁸ represents an alkylene group having 1 to 12 carbon atoms and is basically as defined above for R⁷ in the general formula (7); and

R⁹ represents an alkyl group having 1 to 8 carbon atoms, an aralkyl group having 7 to 18 carbon atoms, or an aryl group having 6 to 18 carbon atoms, each of which may be branched.

Specific examples of the alkyl group having 1 to 8 carbon atoms which may be branched include a methyl group, an ethyl group, a propyl group, an isopropyl group, an n-butyl group, an isobutyl group, a sec-butyl group, a tert-butyl group, an n-pentyl group, an isopentyl group, a neopentyl group, a tert-pentyl group, a 1-methylbutyl group, a 2-methylbutyl group, and 1,2-dimethylpropyl group, each of which may contain a double bond or a triple bond. Of those, a methyl group or an ethyl group is preferable.

Specific examples of the aralkyl group having 7 to 18 carbon atoms which may be branched include a benzyl group and a phenethyl group.

Specific examples of the aryl group having 6 to 18 carbon atoms include a phenyl group, a methylphenyl group (toluyl group), a dimethylphenyl group, and an ethylphenyl group. In addition to the alkyl groups described above, examples of a substituent for the aryl group include: an alkoxy group such as a methoxy group or an ethoxy group; and a group composed of a halogen atom such as a fluorine atom or a chlorine atom. The aryl group may have two or more of those substituents, and substitution positions are not limited.

Specific examples of the amino group-containing alkoxysilane represented by the general formula (8) include: N-butylaminopropyltrimethoxysilane; N-ethylaminoisobutyltrimethoxysilane; and N-phenyl-γ-aminopropyltrimethoxysilane, N-phenyl-γ-aminopropyltriethoxysilane, and derivatives thereof (such as N-(2-methylphenyl)-γ-aminopropyltrimethoxysilane and N-(3-methylphenyl)-γ-aminopropyltrimethoxysilane).

Of those, N-phenyl-γ-aminopropyltrimethoxysilane is preferable because of sufficiently low reactivity of amine to carry out the condensation reaction of silane under mild conditions at the time of curing.

Furthermore, a commercially available product can be used for the amino group-containing alkoxysilane represented by the general formula (8). For example, Dynasilane 1189 (available from Deggusa-Hulls Co., Ltd.) or A9669 (available from Nippon Unicar Co., Ltd.) can be used.

The condensate of the silane compound (b) is not particular limited as far as it is a compound having a siloxane skeleton, in which at least one amino group binds to a silicon atom through an organic group that may contain a nitrogen atom or an oxygen atom. Specific examples thereof include condensates of the respective amino group-containing alkoxysilanes represented by the general formulae (6) to (8) having cross-linkable silyl groups.

Of those, the condensate of the silane compound (b) is preferably one of γ-aminopropyltrimethoxysilane, γ-aminopropyltriethoxysilane, and the condensates of the respective compounds represented by the general formulae (9) and (10), because the final silica network of the cured product obtained by curing these condensates is dense. In addition, another preferable condensate of the silane compound (b) is a condensate of N-phenyl-γ-aminopropyltrimethoxysilane, because the reactivity at a temperature equal to or lower than room temperature with the silane compound (a) where an epoxy group binds to a silicon atom through an organic group that may contain a nitrogen atom or an oxygen atom (a) is suppressed, so that the resulting curable resin composition of the present invention has excellent storage stability and can be used as a one-component type composition.

Specific examples of the condensate of the silane compound (b) include one having a structure in which, instead of a glycidyl group, an amino group binds through an organic group to a siloxane skeleton which is a chain-like, ladder-like, or basket-like siloxane skeleton represented by the formula (2), (3) or (4), or a combination thereof. The chain-like structure represented by the formula (2) is preferred because of excellent workability and storage stability as well as low viscosity.

The curable resin composition of the present invention has no particular limitation on the method of manufacturing the condensate of the silane compound (b). Examples thereof include a method in which an alkoxysilane containing at least an amino group-containing alkoxysilane is subjected to a hydrolytic condensation reaction to obtain the condensate and a method in which the condensate is synthesized by forming a siloxane skeleton and introducing a compound having an amino group into the siloxane skeleton. In the method according to a preferable embodiment, the condensate of the silane compound (b) is obtained by subjecting the aloxysilane containing at least the amino group-containing alkoxysilane to a hydrolytic condensation reaction.

Incidentally, as alcohol is generated when the siloxan bond is formed by means of hydrolysis and condensation, it is preferable to remove the generated alcohol under reduced pressure.

For example, an alkoxysilane including at least an amino group-containing alkoxysilane can be used as a raw material used for producing the condensate of the silane compound (b). Examples of the alkoxysilane except the amino group-containing alkoxysilane include: a substituted alkoxysilane; and an alkoxysilane represented by the formula (5) such as a tetraalkoxysilane (e.g., tetramethoxysilane or tetraethoxysilane) or a trialkoxysilane (e.g., methyltrimethoxysilane or ethyltrimethoxysilane).

The condensate of the silane compound (b) may be obtained by condensation reaction between the amino group-containing alkoxysilane and, for example, substituted alkoxyslane, alkoxysilane represented by the formula (5), or the condensates thereof. When another silane compound having a functional group other than an amino group is used in combination, the condensate preferably contains at least 60% by mole of the amino group-containing alkoxysilane in term of heat resistance. The condensate more preferably contains not less than 80% by mole of the amino group-containing alkoxysilane because it will provide more excellent heat resistance.

In addition, the condensate of the silane compound (b) preferably contains 60 to 100% by mole of the amino groups with respect to the silicon atoms of the condensate of the silane compound (b) in term of excellent heat resistance. The condensate more preferably contains 80 to 100% by mole of the amino groups with respect to the silicon atoms of the condensate of the silane compound (b) because it will provide more excellent heat resistance.

In the preferred embodiment of the curable resin composition of the present invention, the silane compounds (a) and (b) are condensates.

More particularly, according to a suitable combination, the silane compound (a) is a condensate of 3-glycidoxypropyltrialkoxysilane and the silane compound (b) is a condensate of an amino group-containing alkoxysilane.

Alternatively, in another preferred embodiment, the silane compound (a) is a condensate, while the silane compound (b) is not a condensate. More particularly, according to a suitable combination, the silane compound (a) is a condensate of the 3-glycidoxypropyltrialkoxysilane described above and the silane compound (b) is the amino group-containing alkoxysilane described above.

In such an embodiment, it is particularly preferred that the silane compound (b) be a compound containing only secondary amine (e.g., compounds represented by the general formulae (7) and (8), or condensates thereof), because the ratio of the content of the silane compound (b) to the content of the silane compound (a) is increased, which results in improvement in the retention of the storage modulus of the curable resin composition obtained in the present invention.

In the curable resin composition of the present invention, the ratio of the content of the silane compound (a) to the content of the silane compound (b) is preferably defined so that the equivalent ratio of the epoxy group of the silane compound (a) to the active hydrogen of the amino group in the silane compound (b) is 0.5 to 1.5, more preferably 0.8 to 1.2. This is because the obtained curable resin composition is allowed to have considerably high retention of storage modulus and extremely excellent heat resistance as far as this ratio between the silane compound (a) and the silane compound (b) is within the ranges described above.

<Silane compound (c) where a mercapto group binds to a silicon atom through an organic group that may contain a nitrogen atom or an oxygen atom>

The silane compound (c) where a mercapto group binds to a silicon atom through an organic group that may contain a nitrogen atom or an oxygen atom, as used in the curable resin composition of the present invention, is not particularly limited as far as it is a silane compound in which a mercapto group binds to a silicon atom through an organic group that may contain a nitrogen atom or an oxygen atom and at least a part of the silane compound is a condensate. Hereinafter, the condensate of the silane compound (c) may be also referred to as “a mercapto group-containing silicon compound.”

For example, the silane compound (c) where a mercapto group binds to a silicon atom through an organic group that may contain a nitrogen atom or an oxygen atom may be a mercapto group-containing alkoxysilane or a condensate thereof.

The mercapto group-containing alkoxysilane is not particularly limited as far as it is an alkoxysilane having at least one alkoxysilyl group, in which at least one mercapto group binds to a silicon atom through an organic group that may contain a nitrogen atom or an oxygen atom. A specific example thereof is a mercapto group-containing alkoxysilane having a cross-linkable silyl group and represented by the following general formula (15): 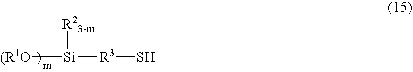
wherein:

m represents an integer number of 2 or 3; and

R¹, R², and R³ are as defined above.

Specific examples of the mercapto group-containing alkoxysilane include 3-mercaptopropyltrialkoxysilanes or 3-mercaptopropylalkyldialkoxysilanes such as 3-mercaptopropyltrimethoxysilane, 3-mercaptopropylmethyldimethoxysilane, 3-mercaptopropylmethyldiethoxysilane, and 3-mercaptopropyltriethoxysilane. Each of them can be used alone, or two or more of them can be used in combination.

Furthermore, a commercially available product may be subjected to hydrolytic condensation and used as the mercapto group-containing alkoxysilane. More specifically, for example, A189 and AZ6129 (available from Nippon Unicar Co., Ltd.) and KBM-802 and KBM-803 (available from Shin-Etsu Chemical Co., Ltd.) can be used.

The condensate of the silane compound (c) is not particularly limited as far as it is a compound having a siloxane skeleton, in which at least one mercapto group binds to a silicon atom through an organic group that may contain a nitrogen atom or an oxygen atom. An example of the condensate of the silane compound (c) is a condensate of a mercapto group-containing alkoxysilane having a cross-linkable silyl group and represented by the general formula (15). The specific example of the condensate of the mercapto group-containing alkoxysilane represented by the general formula (15) can be used for the mercapto group-containing alkoxysilane.

Specific examples of the condensate of the silane compound (c) include one having a structure in which, instead of a glycidyl group, a mercapto group binds through an organic group to a siloxane skeleton which is a chain-, ladder-, or basket-like siloxane skeleton represented by the formula (2), (3) or (4) or a combination thereof. A chain structure represented by the formula (2) is preferred because of low viscosity as well as excellent workability and storage stability.

Moreover, the condensate of the silane compound (c) is preferably manufactured using 3-mercaptopropyltrialkoxysilane as a raw material because of the easy availability of the raw material and the high reactivity.

A method of manufacturing the condensate of the silane compound (c) is not particularly limited, and examples thereof include a method in which an alkoxysilane containing at least a mercapto group-containing alkoxysilane is subjected to a hydrolytic condensation reaction to obtain the condensate and a method in which the condensate is synthesized by forming a siloxane skeleton and introducing a compound having a mercapto group into the siloxane skeleton. Of those, in a preferred embodiment, the method in which an alkoxysilane containing at least a mercapto group-containing alkoxysilane is subjected to a hydrolytic condensation reaction to obtain the condensate is utilized.

Since alcohol is generated at the time of the formation of the siloxane bond through hydrolysis and condensation reaction, it is preferred that the generated alcohol be removed under reduced pressure when the condensate of the silane compound (c) is manufactured.

A condensate in which a mercapto group-containing alkoxysilane is condensed with a substituted alkoxysilane, an alkoxysilane represented by the formula (5) such as tetraalkoxysilane (e.g., tetramethoxysilane or tetraethoxysilane) or trialkoxysilane (e.g., methyltrimethoxysilane or ethyltrimethoxysilane), or a condensate thereof may be used as the condensate of the silane compound (c). If a silane compound having a functional group other than a mercapto group is used in combination, the silane compound preferably contains at least 60% by mole of a mercapto group-containing alkoxysilane in terms of curing rate. The silane compound more preferably contains 90% by mole or more of a mercapto group-containing alkoxysilane because the curing time can be further shortened.

The condensate of the silane compound (c) preferably has 60 to 100% by mole of mercapto groups relative to silicon atoms of the condensate of the silane compound (c) in terms of curing rate. The condensate of the silane compound (c) has more preferably 70 to 100% by mole, still more preferably more than 90% by mole of mercapto groups relative to silicon atoms of the condensate of the silane compound (c), because the curing time can be further shortened.

The condensate of the silane compound (c) is preferably obtained by reacting an alkoxysilane containing at least a mercapto group-containing alkoxysilane, with 0.5 to 1.3 mole of water per mole of silicon atoms of the alkoxysilane containing at least the mercapto group-containing alkoxysilane. Under this condition, hydrolytic condensation is performed and the degree of condensation for the obtained condensate of silane compound (c) is adjusted, thereby obtaining the condensate of the silane compound (c) having low viscosity as well as excellent heat resistance and storage stability. In view of the excellent properties, the molar ratio of water to silicon atoms of the alkoxysilane containing at least a mercapto group-containing alkoxysilane in the reaction is more preferably 0.6 to 1.3 and still more preferably 0.8 to 1.2.

If the hydrolytic condensation is performed using the mercapto group-containing alkoxysilane in combination with the other alkoxysilane such as the substituted alkoxysilane described above, water is added in the amount defined above to the whole of the silicon atoms of the alkoxysilanes.

It is preferred that the condensate of the silane compound (c) have a weight average molecular weight of 350 to 10,000 because of its excellent heat resistance and its viscosity that is not too high. The weight average molecular weight is more preferably 700 to 9,000 and still more preferably 1,000 to 8,000 because of these further improved properties.

A catalyst can be used in the hydrolytic condensation and the hydrolytic condensation can be performed in the presence or absence of a solvent. The types and amounts of a catalyst and a solvent used are as described above.

The silane compound (a) and the silane compound (c) are preferably included in the curable resin composition of the present invention so that the equivalent ratio of the active hydrogen of the mercapto group of the silane compound (c) to the epoxy group of the silane compound (a) is 0.5 to 1.5, more preferably 0.8 to 1.2. When the silane compound (a) and the silane compound (c) are included in the ranges described above, the obtained curable resin composition is allowed to have considerably high retention of the storage modulus and significantly excellent heat resistance.

<Silane compound (d) where an acid anhydride group binds to a silicon atom through an organic group that may contain a nitrogen atom or an oxygen atom>

The silane compound (d) where an acid anhydride group binds to a silicon atom through an organic group that may contain a nitrogen atom or an oxygen atom, as used in the curable resin composition of the present invention, is not particularly limited as far as it is a silane compound in which an acid anhydride group binds to a silicon atom through an organic group that may contain a nitrogen atom or an oxygen atom and at least a. part of the silane compound is a condensate. Hereinafter, the condensate of the silane compound (d) may be also referred to as “an acid anhydride group-containing silicone compound.”

For example, the silane compound (d) where an acid anhydride group binds to a silicon atom through an organic group that may contain a nitrogen atom or an oxygen atom may be acid anhydride group-containing alkoxysilane or a condensate thereof.

The acid anhydride group-containing alkoxysilane is not particularly limited as far as it is an alkoxysilane having at least one alkoxysilyl group, in which at least one acid anhydride group binds to a silicon atom through an organic group that may contain a nitrogen atom or an oxygen atom. A specific example thereof is an acid anhydride group-containing alkoxysilane having a cross-linkable silyl group and represented by the following general formula (16): 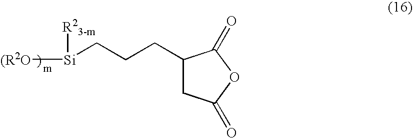
wherein:

m represents an integer number of 2 or 3; and

R² is as defined above, and one R² may be identical with or different from another R².

Specific examples of the acid anhydride group-containing alkoxysilane include 3-(trimethoxysilyl)propylsuccinic anhydride, 3-(methyldimethoxysilyl)propylsuccinic anhydride, 3-(triethoxysilyl)propylsuccinic anhydride, and 3-(methyldiethoxysilyl)propylsuccinic anhydride. Each of them can be used alone or two or more of them can be used in combination.

Furthermore, a commercially available product may be subjected to hydrolytic condensation and used as the acid anhydride group-containing alkoxysilane. More specifically, for example, GENIOSIL GF20 (available from Wacker Corp.) can be used.

Specific examples of the condensate of the silane compound (d) include one having a structure in which, instead of a glycidyl group, an acid anhydride group binds, through an organic group, to a siloxane skeleton which is a chain-, ladder-, or basket-like siloxane skeleton represented by the formula (2), (3) or (4) or a combination thereof. The chain structure represented by the formula (2) is preferred because of low viscosity as well as excellent workability and storage stability.

A method of manufacturing the condensate of the silane compound (d) is not particularly limited, and examples thereof include a method in which an alkoxysilane containing at least an acid anhydride group-containing alkoxysilane is subjected to a hydrolytic condensation reaction to obtain the condensate and a method in which the condensate is synthesized by forming a siloxane skeleton and introducing a compound having an acid anhydride group into the siloxane skeleton. Of those, the method in which an alkoxysilane containing at least an acid anhydride group-containing alkoxysilane is subjected to a hydrolytic condensation reaction to obtain the condensate is utilized in a preferred embodiment.

Since alcohol is generated at the time of the formation of the siloxane bond through hydrolysis and condensation reaction, it is preferred that the generated alcohol be removed under reduced pressure when the condensate of the silane compound (d) is manufactured.

A condensate in which an acid anhydride group-containing alkoxysilane is condensed with a substituted alkoxysilane, an alkoxysilane represented by the formula (5) such as tetraalkoxysilane (e.g., tetramethoxysilane or tetraethoxysilane) or trialkoxysilane (e.g., methyltrimethoxysilane or ethyltrimethoxysilane), or a condensate thereof may be used as the condensate of the silane compound (d). If an alkoxysilane having a functional group other than an acid anhydride group is used in combination, the alkoxysilane preferably contains at least 60% by mole of an acid anhydride group-containing alkoxysilane in terms of curing rate.

The condensate of the silane compound (d) preferably has 60 to 100% by mole of acid anhydride groups relative to silicon atoms of the condensate of the silane compound (d) in terms of curing rate. The condensate of the silane compound (d) has more preferably 80 to 100% by mole of acid anhydride groups relative to silicon atoms of the condensate of the silane compound (d).

When a silanol condensate having an acid anhydride group as described in JP 2003-287617 A is produced, a carboxylic acid is always generated owing to the reaction between one acid anhydride group of an acid dianhydride and an amino group of an amino group-containing alkoxysilane. Moreover, because the molecular weight per silicon atom is large, the ratio of the siloxane bond in a cured product decreases relatively, resulting in reduced heat resistance. In addition, such a compound is generally in a solid state at room temperature, so that it should be diluted with a polar solvent before use. Thus, a cured product can be produced with poor workability, causing a large impact on the environment.

Therefore, the inventors of the present invention have made intensive studies and found that, by performing the hydrolytic condensation of an alkoxysilane containing at least an acid anhydride group-containing alkoxysilane under a certain condition, an alkoxy group can be preferentially hydrolyzed and condensed and thus the obtained condensate of the silane compound (d) is in a liquid state at room temperature, and has improved heat resistance and increased storage stability. More specifically, preferred is a condensate of the silane compound (d) obtained by reacting the alkoxysilane containing at least an acid anhydride group-containing alkoxysilane, with 0.5 to 1.3 moles of water per mole of silicon atoms of the alkoxysilane. In addition, it is preferable to perform the reaction while removing under reduced pressure alcohol generated at the time of the formation of the siloxane bond through a hydrolytic condensation reaction when the silane compound (d) is produced. This can promote the condensation with the reaction between alcohol and an acid anhydride avoided.

Under this condition, hydrolytic condensation is performed and the degree of condensation for the obtained condensate of the silane compound (c) is adjusted, thereby obtaining the condensate of the silane compound (d) having low viscosity as well as excellent heat resistance and storage stability. Moreover, an acid anhydride group with almost no ring-opening remains in this compound, so the obtained composition has high curing rate. The amount of water to be reacted is more preferably 0.6 to 1.3 moles and still more preferably 0.8 to 1.2 moles per mole of silicon atoms of the alkoxysilane containing at least acid anhydride group-containing alkoxysilane, because these properties are further improved. If the hydrolytic condensation is performed using an acid anhydride group-containing alkoxysilane in combination with the other alkoxysilane such as the substituted alkoxysilane described above, water is added in the amount defined above to the whole of the silicon atoms of these alkoxysilanes.

It is preferred that the condensate of the silane compound (d) have a weight average molecular weight of 500 to 10,000 because of its excellent heat resistance and its viscosity that is not too high. The weight average molecular weight is more preferably 600 to 9,000 and still more preferably 700 to 8,000 because of these further improved properties.

A catalyst can be used in the hydrolytic condensation and the hydrolytic condensation can be performed in the presence or absence of a solvent. The types and amounts of a catalyst and a solvent used are as described above.

The silane compound (a) and the silane compound (d) are preferably included in the curable resin composition of the present invention so that the equivalent ratio of the active hydrogen of the carboxy group which may be generated from the silane compound (d) to the epoxy group of the silane compound (a) is 0.5 to 1.5, more preferably 0.8 to 1.2. When the silane compound (a) and the silane compound (d) are included in the ranges described above, the obtained curable resin composition is allowed to have considerably high retention of the storage modulus and significantly excellent heat resistance.

Additionally, at least one selected from the group consisting of the silane compounds (b) to (d) and the silane compound (a) are preferably included in the curable resin composition of the present invention such that the equivalent ratio of the whole of active hydrogen of the amino group of the silane compound (b); active hydrogen of the mercapto group of the silane compound (c); and active hydrogen of the carboxyl group generated from the silane compound (d) to the epoxy group of the silane compound (a) is 0.5 to 1.5 and more preferably 0.8 to 1.2. When the silane compound (a) and the silane compounds (b) to (c) are included in the ranges described above, the obtained curable resin composition is allowed to have considerably high retention of the storage modulus and significantly excellent heat resistance.

Preferably, the curable resin composition of the present invention further contains a curing catalyst. Specific examples of the curing catalyst include: imidazoles such as 2-methylimidazole, 2-ethylimidazole, and 2-ethyl-4-methylimidazole; tertiary amines such as 2-(dimethylaminomethyl)phenol, 2,4,6-tris(dimethylaminomethyl)phenol represented by the following formula (8), and 1,8-diaza-bicyclo(5,4,0)undecene; phosphines such as triphenylphosphine; metallic compounds such as tin octylate; and quaternary phosphonium salts. Of those, a compound represented by the following formula (17) is preferred in terms of strong catalysis.

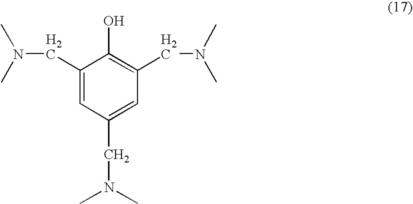

The content of the curing catalyst is preferably 0.01 to 15 parts by weight, more preferably 0.1 to 10 parts by weight with respect to 100 parts by weight of the silane compound (a) where an epoxy group binds to a silicon atom through an organic group that may contain a nitrogen atom or an oxygen atom.

The curable resin composition of the present invention can contain, other than the above components, a variety of additives including fillers, plasticizers, antioxidants, age resistors, pigments, thixotropy-imparting agents, tackifiers, flame retardants, dyes, antistatic agents, dispersants, and solvents without departing from the scope of the invention.

Examples of the filler include organic or inorganic fillers of various shapes. Specific examples thereof include: fumed silica, sintered silica, precipitated silica, pulverized silica, and molten silica; diatomaceous earth; iron oxide, zinc oxide, titanium oxide, barium oxide, and magnesium oxide; calcium carbonate, magnesium carbonate, and zinc carbonate; pyrophyllite clay, kaolin clay, and sintered clay; carbon black; and fatty acid-treated products, resin acid-treated products, urethane compound-treated products, and fatty acid ester-treated products thereof. The content of the filler is preferably not more than 90% by weight of the entire composition in terms of physical properties of a cured product.

Of those, calcium carbonate, especially surface-treated calcium carbonate is contained in the curable resin composition, so that viscosity is easily adjusted. In addition, good initial thixotropy and storage stability can be obtained.

As such calcium carbonate, surface-treated calcium carbonate conventionally known, whose surface is treated with a fatty acid, a resin acid, a urethane compound, or fatty acid ester, can be used. In particular, calcium carbonate preferably used, which is surface-treated with, for example a fatty acid includes KALFAIN 200 (available from Maruo Calcium Co., Ltd.) and WHITON 305 (calcium carbonate heavy; available from Shiraishi Calcium Co., Ltd.). Alternatively, as calcium carbonate which is surface-treated with fatty acid ester, SEALETS200 (available from Maruo Calcium Co., Ltd.) can be preferably used.

Specific examples of the plasticizer include: dioctyl phthalate (DOP) and dibutyl phthalate (DBP); dioctyl adipate and isodecyl succinate; diethylene glycol dibenzoate and pentaerythritol ester; butyl oleate and methyl acetylricinoleate; tricresyl phosphate and trioctyl phosphate; and propylene glycol adipate polyester and butylene glycol adipate polyester. Each of them may be used alone, or two or more of them can be mixed. The content of the plasticizer is preferably not more than 50 parts by weight with respect to 100 parts by weight of the total of the silane compound (a) and at least one compound selected from the group consisting of the silane compound (b), the silane compound (c), and the silane compound (d) from the viewpoint of workability.

Specific examples of the antioxidant include butylated hydroxytoluene (BHT) and butylated hydroxyanisole (BHA).

Specific examples of the age resistor include hindered phenol-based compounds.

Specific examples of the pigment include: inorganic pigments such as titanium oxide, zinc oxide, ultramarine, red oxide, lithophone, lead, cadmium, iron, cobalt, aluminum, hydrolochloride, and sulfate; and organic pigments such as an azo pigment, a phthalocyanine pigment, a quinacridone pigment, a quinacridone quinone pigment, a dioxazine pigment, an anthrapyrimidine pigment, an anthanthrone pigment, an indanthrone pigment, a flavanthrone pigment, a perylene pigment, a perinone pigment, a diketopyrrolopyrrole pigment, a quinophthalone pigment, an anthraquinone pigment, a thioindigo pigment, a benzimidazolone pigment, an isoindoline pigment, and carbon black.

Specific examples of the thixotropy-imparting agent include Aerosil (available from Nippon Aerosil Co., Ltd.) and Disparlon (available from Kusumoto Chemicals, Ltd.).

Specific examples of the tackifier include a terpene resin, a phenol resin, a terpene-phenol resin, a rosin resin, and a xylene resin.

Specific examples of the flame retardant include chloroalkylphosphate, dimethylmethylphosphonate, a bromine/phosphorous compound, ammonium polyphosphate, neopentyl bromide-polyether, and brominated polyether.

Examples of the antistatic agent generally include: a quaternary ammonium salt; and a hydrophilic compound such as polyglycol or an ethylene oxide derivative.

The curable resin composition of the present invention can be produced by generally known methods. For example, it can be obtained by mixing and dispersing the silane compound (a), one selected from the group consisting of the silane compound (b), the silane compound (c), and the silane compound (d) and the curing catalyst and additives optionally added under a nitrogen atmosphere using a stirrer.

The curable resin composition of the present invention having two components can utilize the silane compound (a) as a main material and one selected from the group consisting the silane compound (b), the silane compound (c), and the silane compound (d) as a curing agent. The catalyst and additives can be contained in one or both of the main material and the curing agent.

If the condensate of the silane compound (d) is used alone as a curing agent for the silane compound (a), it can be used as the one-component type cured by the utilization of moisture such as humidity in air or under heating.

The curable resin composition of the present invention has smaller change in storage modulus (G′) at lower and higher temperatures, and has much higher heat resistance than the conventional curable resin composition using an epoxy silica hybrid body. Furthermore, if hydrolytic condensation is performed under a certain condition for producing the condensates of the silane compound (a), the silane compound (b), the silane compound (c), and the silane compound (d), low viscosity as well as excellent workability and storage stability can be obtained.

The curable resin composition of the present invention has excellent properties as described above and thus can be preferably used in the application for paints, anticorrosive paints, adhesives, or sealants. In particular, it can be used in the application for printed circuit boards, semiconductor sealants, and matrix resins for FRPs typified by the use in aircraft, which require excellent heat resistance.

Next, the cured product of the present invention will be described.

The cured product of the present invention can be obtained by curing a curable resin composition which contains the silane compound (a) where an epoxy group binds to a silicon atom through an organic group that may contain a nitrogen atom or an oxygen atom, and at least one selected from the group consisting of the silane compound (b) where an amino group binds to a silicon atom through an organic group that may contain a nitrogen atom or an oxygen atom, the silane compound (c) where a mercapto group binds to a silicon atom through an organic group that may contain a nitrogen atom or an oxygen atom, and the silane compound (d) where an acid anhydride group binds to a silicon atom through an organic group that may contain a nitrogen atom or an oxygen atom, and in which at least a part of at least one selected from the group consisting of the silane compound (a), the silane compound (b), the silane compound (c), and the silane compound (d) is a condensate.

The curable resin composition used in the cured product of the present invention is not particularly limited as far as it contains the silane compound (a) where an epoxy group binds to a silicon atom through an organic group that may contain a nitrogen atom or an oxygen atom, and at least one selected from the group consisting of the silane compound (b) where an amino group binds to a silicon atom through an organic group that may contain a nitrogen atom or an oxygen atom, the silane compound (c) where a mercapto group binds to a silicon atom through an organic group that may contain a nitrogen atom or an oxygen atom, and the silane compound (d) where an acid anhydride group binds to a silicon atom through an organic group that may contain a nitrogen atom or an oxygen atom, and at least a part of at least one selected from the group consisting of the silane compound (a), silane compound (b), the silane compound (c), and the silane compound (d) is a condensate. For example, the curable resin compositions of the present invention described above can be preferably used. The illustrated curable resin compositions of the present invention can be used as the curable resin composition used in the cured product of the present invention.

Preferably, the cured product of the present invention includes a cured product obtained by curing the curable resin composition used as a resin matrix component for printed circuit boards, semiconductor sealants, resins for aircraft, and the like and a coated material obtained by applying or impregnating the curable resin composition to or into an adherend.

Curing methods are not particularly limited. For example, curing can be performed according to any conventionally known method.

### EXAMPLES

Hereinafter, the present invention will be described more specifically by reference to examples. It will be understood that the present invention is not limited to those examples.

<Synthesis of Silane Compound (A)>

After 100 g of tetrahydrofuran (THF) was dissolved in 236 g of 3-glycidoxypropyltrimethoxysilane (A187, available from Nippon Unicar Co., Ltd.), 54 g of water and subsequently a catalytic amount of dibutyltin dilaurate were added thereto and stirred at 80° C. for 8 hours. THF and methanol liberated during the reaction were then removed under reduced pressure to obtain 180 g of a viscous epoxysilane condensate A (epoxy equivalent: 180).

<Synthesis of Silane Compound (B)>

In a flask, 100 g of N-phenyl-γ-aminopropyltrimethoxysilane (0.39 mol; A9669, available from Nippon Unicar Co., Ltd.) and 7 g of water (0.39 mol) were mixed in the presence of a tin catalyst (dibutyltin dilaurate) and stirred at 40° C. for 24 hours. Methanol liberated during the reaction was then removed under reduced pressure to obtain 80 g of an amino group-containing silane condensate B (amine equivalent: 209).

<Synthesis of Silane Compound (C)>

In a flask, 200 g of γ-aminopropyltrimethoxysilane (1.12 mol; A1110, available from Nippon Unicar Co., Ltd.) and 106 g of MIPK (1.23 mol) were mixed in the presence of a tin catalyst (dibutyltin dilaurate) and stirred at 40° C. for 24 hours. At this time, the carbonyl group of MIPK was present in an equivalent ratio of 1.1 with respect to the amino group of γ-aminopropyltrimethoxysilane. Methanol liberated during the reaction and an excess of MIPK were then removed under reduced pressure to obtain 225 g of a ketimine group-containing silane condensate C (ketimine equivalent: 201).

### Example 1

With 5 g of water, 50 g of the epoxysilane condensate A obtained as above and 58 g of the amino group-containing silane condensate B obtained as above (1.0 eq) were mixed, followed by curing at 25° C. for 2 weeks to obtain a room temperature cured product.

Further, the room temperature cured product was cured with the temperature increased from 60° C. up to 200° C. in approximately 12 hours to obtain a heat cured product.

### Comparative Example 1

With 9.5 g of water, 100 g of a bisphenol A type epoxy resin (EP4100E, available from ASAHI DENKA Co., LTD.) and 53 g of the ketimine group-containing silane condensate C obtained as above (1.0 eq) were mixed, followed by curing at 25° C. for 2 weeks to obtain a room temperature cured product.

Further, the room temperature cured product was cured with the temperature increased from 60° C. up to 200° C. in approximately 12 hours to obtain a heat cured product.

The heat cured products prepared in Example 1 and Comparative Example 1 were heated from 30° C. up to 250° C. at a heating rate of 2° C./min. Subsequently, the dependence of the storage modulus (E′) and the loss tangent (tan δ) on temperature were examined. The result is shown below in Table 1.

TABLE 1

| | | Comparative Example | |
|---|---|---|---|
| | | 1 | Example 1 |
| Modulus of | 30° C. | 22.1 × 10⁸ | 20 × 10⁸ |
| Elasticity (Pa) | 250° C. | 3.8 × 10⁸ | 18 × 10⁸ |

| | | |
|---|---|---|
| Retention (%) | 17 | 90 |

As is apparent from the result shown in Table 1 above, the heat cured product (Example 1) of the curable resin composition according to the present invention has higher retention of storage modulus and lower loss tangent than the heat cured product (Comparative Example 1) of the conventional curable resin composition in which an epoxy resin and a ketimine group-containing silane condensate are simply mixed. Thus, the curable resin composition of the present invention has excellent heat resistance as compared to the conventional curable resin composition.

<Synthesis of Epoxy Group-Containing Silicone Compound (D)>

With 236 g of 3-glycidoxypropyltrimethoxysilane (1.00 mol; A187, available from Nippon Unicar Co., Ltd.), 18 g of water (1.00 mol) and 0.2 g of dibutyltin dilaurate were mixed and then stirred at 80° C. for 8 hours. Subsequently, methanol generated from the reaction was removed under reduced pressure to obtain a liquid epoxy group-containing silicone compound (D) with the epoxy equivalent of 190 g/eq (theoretical value).

<Synthesis of Epoxy Group-Containing Silicone Compound (E)>

A liquid epoxy group-containing silicone compound (E) with the epoxy equivalent of 180 g/eq (theoretical value) was obtained by synthesis in the same manner as the epoxy group-containing silicone compound (D) except that the amount of water used was changed to 21.6 g (1.20 mol).

<Synthesis of Epoxy Group-Containing Silicone Compound (F)>

After mixing 153 g of 3-glycidoxypropyltrimethoxysilane (0.65 mol; A187, available from Nippon Unicar Co., Ltd.), 49 g of methyltrimethoxysilane (0.35 mol), 18 g of water (1.00 mol) and 0.2 g of dibutyltin dilaurate, the mixture was stirred at 80° C. for 8 hours. Methanol generated from the reaction was then removed under reduced pressure to obtain a liquid epoxy group-containing silicone compound (F) with the epoxy equivalent of 240 g/eq (theoretical value).

<Synthesis of Epoxy Group-Containing Silicone Compound (G)>

A liquid epoxy group-containing silicone compound (G) with the epoxy equivalent of 167 g/eq (theoretical value) was obtained by synthesis in the same manner as the epoxy group-containing silicone compound (D) except that the amount of water used was changed to 54 g (3.00 mol).

<Synthesis of Mercapto Group-containing Silicone Compound (H)>

To 196 g of 3-mercaptopropyltrimethoxysilane (1.00 mol; A189, available from Nippon Unicar Co., Ltd.), 12.6 g of water (0.70 mol) was added and then stirred at 80° C. for 15 hours in the absence of a catalyst. Subsequently, methanol generated from the reaction was removed under reduced pressure to obtain a liquid mercapto group-containing silicone compound (H) with the SH equivalent of 164 g/eq (theoretical value).

<Synthesis of Mercapto Group-containing Silicone Compound (I)>

A liquid mercapto group-containing silicone compound (I) with the SH equivalent of 136 g/eq (theoretical value) was obtained by synthesis in the same manner as the mercapto group-containing silicone compound (H) except that the amount of water used was changed to 23.4 g (1.30 mol).

<Synthesis of Acid Anhydride Group-containing Silicone Compound (J)>

With 10 g of 3-(trimethoxysilyl)propylsuccinic anhydride (0.028 mol; X-12-967, available from Shin-Etsu Chemical Co., Ltd.), 0.660 g of water (0.036 mol) and 10 mg of triethylamine were mixed and stirred at room temperature for about 1 hour while reducing pressure to such an extent that methanol generated from the reaction can be removed. Consequently, a slightly yellowish clear liquid was obtained. Then, methanol generated from the reaction by heating under reduced pressure was completely removed to obtain a reddish liquid acid anhydride group-containing silicone compound (J) (mixture).

From the resultant liquid, the integration value of proton components of the methoxy group and SiCH₂ was calculated by ¹H-NMR. The result revealed that the integration ratio between the two was 4.3:2.0.

In addition, the broad peak was observed at around 3.8 ppm. This is considered to be the peak of methyl(ester) of the condensate in which an acid anhydride group has been ring-opened and the reaction such as esterification has occurred.

The production ratio of the target condensate (acid anhydride group-containing silicon compound) to the condensate whose acid anhydride group had been ring-opened was approximately 4:1 based on the integration ratio.

Furthermore, the attribution of the substituent was performed by Fourier transform infrared spectroscopy (FTIR). As a result, the absorption which may be attributed to the carbonyl stretching vibration of the acid anhydride group was observed at 1860 cm⁻¹ and 1780 cm⁻¹ (the succinic anhydride has absorption at 1865 cm⁻¹ and 1782 cm⁻¹). Similarly, the absorption which may be attributed to the carbonyl stretching vibration of the carboxy group generated by the ring-opening of the acid anhydride group was observed at 1720 cm⁻¹.

<Evaluation of Storage Stability of Epoxy Group-containing Silicone Compounds (D) to (G)>

The viscosity immediately after the synthesis of the epoxy group-containing silicone compounds (D) to (G) obtained as above, as well as the viscosity after leaving them under the sealing condition at 20° C. for 1 week were measured with an E type viscometer to determine the rate of viscosity increase relative to the initial viscosity. The result is shown in Table 2 below.

TABLE 2

| | Rate of Viscosity |
|---|---|
| | Increase (times) |
| Epoxy group-containing silicone | 1.2 |
| compound (D) | |
| Epoxy group-containing silicone | 1.8 |
| compound (E) | |
| Epoxy group-containing silicone | 1.7 |
| compound (F) | |
| Epoxy Group-containing silicone | >10 |
| compound (G) | |

As shown in Table 2 above, the epoxy group-containing silicone compounds (D) to (F) which have been obtained by adding water at a molar ratio of 1.00 or 1.20 with respect to the silicon atom of 3-glycidoxypropyltrimethoxysilane (and methyltrimethoxysilane) followed by hydrolytic condensation have viscosity increase at a low rate of 1.2 to 1.8 and have excellent storage stability, while the epoxy group-containing silicone compound (G) which has been obtained by adding water at a molar ratio of 3.00 followed by performing hydrolytic condensation has the rate of viscosity increase 10 times or more that of the initial viscosity.

### <Examples 2 to 7 and Comparative Examples 2 to 4>

Each of components shown below in Table 3 was mixed at the composition ratio (part by weight) shown in Table 3 below using a stirrer, and dispersed to obtain curable resin compositions listed in Table 3, respectively.

The heat resistance of the resultant curable resin compositions was evaluated by measuring the retention of the storage modulus (G′) as follows. The result is shown in Table 2.

<Measurement Method of Retention of Storage Modulus>

(1) Preparation of Sample

Each of the curable resin compositions of Examples 2 to 7 was poured into a steel mold to which a mold release agent had been applied, and cured for 2 hours at a temperature of 23° C. and humidity of 60%, followed by curing at 80° C. for 2 hours, at 120° C. for 1 hour and at 180° C. for 1 hour to harden them. The resultant cured products (45 mm long×12 mm wide×1 mm high) were used as samples.

For the curable resin compositions of Comparative Examples 2 and 3, samples were prepared in the same manner as the above samples except that the curing condition was changed as follows: curing for 2 hours at a temperature of 23° C. and humidity of 60%, followed by curing at 80° C. for 2 hours, at 120° C. for 1 hour and at 150° C. for 1 hour. Alternatively, for the curable resin composition of Comparative Example 4, a sample was prepared in the same manner as the above samples except that the curing condition was changed as follows: at 80° C. for 2 hours, at 120° C. for 2 hours and at 150° C. for 2 hours. (2) Measurement of Retention of Storage Modulus For samples (1), G′ (200° C.) and G′ (20° C.) that were the storage modulus at temperatures of 200° C. and at 20° C. at the time of the forced extensional vibration with strain of 0.01% and frequency of 10 Hz were measured respectively to determine the modulus retention (%) according to the following formula:

Modulus Retention (%)=100×G′ (200° C.)/G′ (20° C.)

TABLE 3

| | | | | | | | Comparative | | |
|---|---|---|---|---|---|---|---|---|---|
| | Examples | | | | | | Examples | | |
| | 2 | 3 | 4 | 5 | 6 | 7 | 2 | 3 | 4 |
| Epoxy group- | 100 | 100 | 50 | | | 100 | | | |
| containing silicone | | | | | | | | | |
| compound (D) | | | | | | | | | |
| Epoxy group- | | | | 100 | | | | | |
| containing silicone | | | | | | | | | |
| compound (E) | | | | | | | | | |
| Epoxy group- | | | | | 100 | | | | |
| containing silicone | | | | | | | | | |
| compound (F) | | | | | | | | | |
| Bisphenol A type | | | 50 | | | | 100 | 100 | 100 |
| epoxy resin | | | | | | | | | |
| Mercapto group- | 86 | | 86 | 88 | 68 | | | | |
| containing silicone | | | | | | | | | |
| compound (H) | | | | | | | | | |
| Mercapto group- | | 71 | | | | | | | |
| containing silicone | | | | | | | | | |
| compound (I) | | | | | | | | | |
| Acid anhydride group- | | | | | | 120 | | | |
| containing silicone | | | | | | | | | |
| compound (J) | | | | | | | | | |
| MXDA | | | | | | | 17.8 | | |
| Mercaptan | | | | | | | | 70 | |
| Methyltetrahydrophthalic | | | | | | | | | 80 |
| anhydride | | | | | | | | | |
| Curing catalyst | 3 | 3 | 3 | 3 | 3 | 0.5 | | 3 | 0.5 |
| Silica | 150 | 150 | 150 | 150 | 150 | 150 | 150 | 150 | 150 |
| Modulus retention (%) | 80 | 85 | 60 | 85 | 85 | 75 | 0.3 | 0.1 | 0.2 |

Each of components in Table 3 is as follows: Bisphenol A type epoxy resin: EPIKOTE 828 available from Japan Epoxy Resin Co., Ltd. MXDA (meta-xylylenediamine): product available from Mitsubishi Gas Chemical Co., Ltd. Mercaptan: Capcure 3-800 available from Japan Epoxy Resin Co., Ltd. Methyltetrahydrophthalic anhydride: Rikacid MT-500 available from New Japan Chemical Co., Ltd. Curing Catalyst (compound represented by the formula (17)): (DMP-30), available from Tokyo Kasei Kogyo Co., Ltd. Silica: spherical silica having average particle size of 10 μm

As is obvious from the result shown in Table 3, the combinations of the epoxy group-containing silicone compound and the mercapto group-containing silicone compound or acid anhydride group-containing silicone compound (Examples 2 to 7), each of which has a siloxane skeleton, had significantly high modulus retention and highly excellent heat resistance, as compared to the conventional combinations of the bisphenol A type epoxy resin and amine or mercaptan or an acid anhydride (Comparative Examples 2 to 4).

Although Example 3 provides a composition utilizing the mercapto group-containing silicone compound (I) which, when prepared, uses more water than the mercapto group-containing silicone compound (H) used in the composition of Example 2, it has slightly higher retention than the composition of Example 2.

Although Example 4 provides a composition utilizing the general-purpose epoxy resin together with the epoxy group-containing silicone compound, it has slightly lower retention than in Example 2 but much higher retention than in Comparative Examples.

Although Example 5 provides a composition utilizing the epoxy group-containing silicone compound (E) which, when prepared, uses more water than the epoxy group-containing silicone compound (D) used in the composition of Example 2, it has slightly higher retention than the composition of Example 2.

Although Example 6 provides a composition utilizing the epoxy group-containing silicone compound (F) obtained by co-condensing glycidoxytrimethoxysilane with methyltrimethoxysilane, it has slightly higher retention than the composition of Example 2.

Although Example 7 provides a combination of the epoxy group-containing silicone compound and the acid anhydride group-containing silicone compound, it has the retention almost equal to that of the compositions utilizing the mercapto group-containing silicone compound (Example 2 to 6).

1. A curable resin composition comprising:
a silane compound (a) where an epoxy group binds to a silicon atom through an organic group that may contain a nitrogen atom or an oxygen atom, and
at least one selected from the group consisting of:
a silane compound (b) where an amino group binds to a silicon atom through an organic group that may contain a nitrogen atom or an oxygen atom;
a silane compound (c) where a mercapto group binds to a silicon atom through an organic group that may contain a nitrogen atom or an oxygen atom; and
a silane compound (d) where an acid anhydride group binds to a silicon atom through an organic group that may contain a nitrogen atom or an oxygen atom,
wherein at least a part of at least one selected from the group consisting of the silane compound (a), the silane compound (b), the silane compound (c), and the silane compound (d) comprises a condensate.

2. The curable resin composition according to claim 1, wherein the condensate of the silane compound (a) comprises a condensate of 3-glycidoxypropyltrialkoxysilane.

3. The curable resin composition according to claim 1, wherein the condensate of the silane compound (a) is obtained by subjecting an alkoxysilane containing at least an epoxy group-containing alkoxysilane to a hydrolytic condensation reaction.

4. The curable resin composition according to claim 3, wherein the condensate of the silane compound (a) is obtained by subjecting the alkoxysilane containing at least an epoxy group-containing alkoxysilane to a reaction with 0.5 to 1.3 times mole of water with respect to silicon atoms of the alkoxysilane containing at least an epoxy group-containing alkoxysilane.

5. The curable resin composition according to claim 1, wherein the condensate of the silane compound (a) contains 60 to 100% by mole of epoxy groups with respect to silicon atoms of the condensate of the silane compound (a).

6. The curable resin composition according to claim 1, wherein the condensate of the silane compound (b) comprises a condensate of an amino group-containing alkoxysilane.

7. The curable resin composition according to claim 1, wherein the condensate of the silane compound (c) is obtained by subjecting an alkoxysilane containing at least a mercapto group-containing alkoxysilane to a hydrolytic condensation reaction.

8. The curable resin composition according to claim 7, wherein the condensate of the silane compound (c) is obtained by subjecting the alkoxysilane containing at least a mercapto group-containing alkoxysilane to a reaction with 0.5 to 1.3 times mole of water with respect to silicon atoms of the alkoxysilane containing at least a mercapto group-containing alkoxysilane.

9. The curable resin composition according to claim 1, wherein the condensate of the silane compound (c) contains 60 to 100% by mole of mercapto groups with respect to silicon atoms of the condensate of the silane compound (c).

10. The curable resin composition according to claim 1, wherein the condensate of the silane compound (d) is obtained by subjecting an alkoxysilane containing at least an acid anhydride group-containing alkoxysilane to a hydrolytic condensation reaction.

11. The curable resin composition according to claim 10, wherein the condensate of the silane compound (d) is obtained by subjecting the alkoxysilane containing at least an acid anhydride group-containing alkoxysilane to a reaction with 0.5 to 1.3 times mole of water with respect to silicon atoms of the alkoxysilane containing at least an acid anhydride group-containing alkoxysilane.

12. The curable resin composition according to claim 1, wherein the condensate of the silane compound (d) contains 60 to 100% by mole of an acid anhydride group with respect to silicon atoms of the condensate of the silane compound (d).

13. The curable resin composition according to claim 1, further comprising a curing catalyst.

14. A cured product obtainable by curing a curable resin composition comprising:
a silane compound (a) where an epoxy group binds to a silicon atom through an organic group that may contain a nitrogen atom or an oxygen atom, and
at least one selected from the group consisting of:
a silane compound (b) where an amino group binds to a silicon atom through an organic group that may contain a nitrogen atom or an oxygen atom;
a silane compound (c) where a mercapto group binds to a silicon atom through an organic group that may contain a nitrogen atom or an oxygen atom; and
a silane compound (d) where an acid anhydride group binds to a silicon atom through an organic group that may contain a nitrogen atom or an oxygen atom,
wherein at least a part of at least one selected from the group consisting of the silane compound (a), the silane compound (b), the silane compound (c), and the silane compound (d) comprises a condensate.
